(19) United States
(12) Patent Application Publication
(10) Pub. No.: US 2023/0162426 A1
(43) Pub. Date: May 25, 2023

(54) Image Processing Method, Electronic Device, and Storage Medium

(71) Applicant: Beijing Baidu Netcom Science Technology Co., Ltd., Beijing (CN)

(72) Inventors: Di WANG, Beijing (CN); Chen ZHAO, Beijing (CN); Jie LI, Beijing (CN)

(21) Appl. No.: 17/880,550

(22) Filed: Aug. 3, 2022

(30) Foreign Application Priority Data
Nov. 23, 2021 (CN) 202111396686.7

(51) Int. Cl. G06T 15/04; G06T 11/00; G06T 7/40

(52) U.S. Cl. CPC G06T 15/04; G06T 11/001; G06T 7/40; G06T 2207/20084; G06T 2207/30201

(57) ABSTRACT

An image processing method, an electronic device, and a storage medium are provided, relates to the field of augmented/virtual reality and image processing. A specific implementation solution may include: at least one first texture coefficient of a two-dimensional face image is acquired; a first texture image of the two-dimensional face image is generated based on the at least one first texture coefficient and a first texture base of the two-dimensional face image; the at least one first texture coefficient is determined to satisfy a first target condition based on the first texture image, and the first texture base is updated based on the first texture image, to obtain a second texture base; and in response to the second texture base converging successfully, three-dimensional reconstruction is performed on the two-dimensional face image based on the second texture base, to obtain a three-dimensional face image.

### CROSS REFERENCE TO RELATED APPLICATIONS

The present disclosure claims priority of Chinese Patent Application No. 202111396686.7, filed on Nov. 23, 2021 and named after “Image Processing Method and Apparatus, Electronic device, and Storage medium”. The present disclosure hereby incorporates by reference in its entirety the prior Chinese Patent Application.

### BACKGROUND

### Technical Field

The present disclosure relates to the field of augmented/virtual reality and image processing, and in particular, to an image processing method, an electronic device, and a storage medium in three-dimensional face reconstruction.

### Description of the Related Art

At present, generation of a texture image in face reconstruction depends on a color coverage ability of a texture base and a prediction accuracy of at least one texture coefficient. However, open source methods of the texture base used for performing three-dimensional face reconstruction are all drawn manually.

### SUMMARY

The present disclosure provides an image processing method, an electronic device, and a storage medium.

According to one aspect of the present disclosure, an image processing method is provided. The method may including: at least one first texture coefficient of a two-dimensional face image is acquired; a first texture image of the two-dimensional face image is generated based on the at least one first texture coefficient and a first texture base of the two-dimensional face image; the at least one first texture coefficient is determined to satisfy a first target condition based on the first texture image, and the first texture base is updated based on the first texture image, to obtain a second texture base; and in response to the second texture base converging successfully, three-dimensional reconstruction is performed on the two-dimensional face image based on the second texture base, to obtain a three-dimensional face image.

According to another aspect of the present disclosure, an image processing apparatus is provided. The apparatus may include: an acquisition component, configured to acquire at least one first texture coefficient of a two-dimensional face image; a generation component, configured to generate a first texture image of the two-dimensional face image based on the at least one first texture coefficient and a first texture base of the two-dimensional face image; an update component, configured to determine that the at least one first texture coefficient satisfies a first target condition based on the first texture image, and update the first texture base based on the first texture image, to obtain a second texture base; and a reconstruction component, configured to, in response to the second texture base converging successfully, perform three-dimensional reconstruction on the two-dimensional face image based on the second texture base, to obtain a three-dimensional face image.

According to another aspect of the present disclosure, an electronic device is provided. The electronic device may include at least one processor and a memory communicatively connected to the at least one processor. The memory stores at least one instruction executable by the at least one processor. The at least one instruction is performed by the at least one processor, to cause the at least one processor to perform the following steps: at least one first texture coefficient of a two-dimensional face image is acquired; a first texture image of the two-dimensional face image is generated based on the at least one first texture coefficient and a first texture base of the two-dimensional face image; that the at least one first texture coefficient satisfies a first target condition based on the first texture image is determined, and the first texture base is updated based on the first texture image, to obtain a second texture base; and in response to the second texture base converging successfully, three-dimensional reconstruction is performed on the two-dimensional face image based on the second texture base, to obtain a three-dimensional face image.

According to another aspect of the present disclosure, a non-transitory computer readable storage medium storing a computer instruction is provided. The computer instruction is used for a computer to perform the following steps: at least one first texture coefficient of a two-dimensional face image is acquired; a first texture image of the two-dimensional face image is generated based on the at least one first texture coefficient and a first texture base of the two-dimensional face image; that the at least one first texture coefficient satisfies a first target condition based on the first texture image is determined, and the first texture base is updated based on the first texture image, to obtain a second texture base; and in response to the second texture base converging successfully, three-dimensional reconstruction is performed on the two-dimensional face image based on the second texture base, to obtain a three-dimensional face image.

According to another aspect of the present disclosure, a computer program product is provided, including a computer program. The following steps is implemented when the computer program is performed by at least one processor: at least one first texture coefficient of a two-dimensional face image is acquired; a first texture image of the two-dimensional face image is generated based on the at least one first texture coefficient and a first texture base of the two-dimensional face image; that the at least one first texture coefficient satisfies a first target condition based on the first texture image is determined, and the first texture base is updated based on the first texture image, to obtain a second texture base; and in response to the second texture base converging successfully, three-dimensional reconstruction is performed on the two-dimensional face image based on the second texture base, to obtain a three-dimensional face image.

It should be understood that, the content described in this section is not intended to identify the key or important features of the embodiments of the present disclosure, nor is it intended to limit the scope of the present disclosure. Other features of the present disclosure will become easy to understand through the following description.

### BRIEF DESCRIPTION OF THE DRAWINGS

Drawings are used to better understand the solution, and are not intended to limit the present disclosure. In the figures:

FIG. 1 is a schematic diagram of an image processing method according to an embodiment of the present disclosure.

FIG. 2 is a schematic flowchart of generating a rendering image according to an embodiment of the present disclosure.

FIG. 3 is a schematic diagram of a method for calculating a loss degree shown in

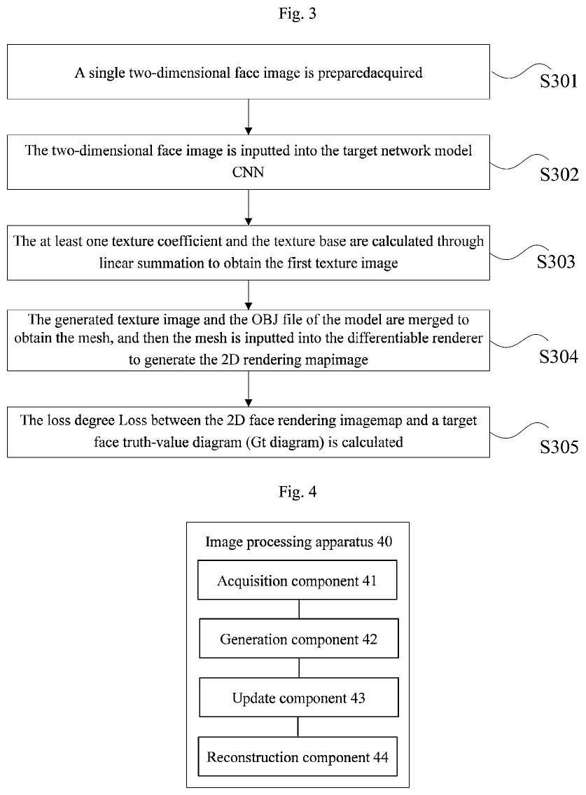

FIG. 2.

FIG. 4 is a structural diagram of an image processing apparatus according to an embodiment of the present disclosure.

FIG. 5 is a schematic block diagram of an electronic device according to an embodiment of the present disclosure.

### DETAILED DESCRIPTION

Exemplary embodiments of the present disclosure are described in detail below with reference to the drawings, including various details of the embodiments of the present disclosure to facilitate understanding, and should be regarded as merely exemplary. Thus, those of ordinary skilled in the art shall understand that, variations and modifications can be made on the embodiments described herein, without departing from the scope and spirit of the present disclosure. Likewise, for clarity and conciseness, descriptions of well-known functions and structures are omitted in the following description.

The image processing method according to an embodiment of the present disclosure is introduced below.

In traditional computer graphics, a texture base is used through a set of fixed orthogonal texture images, and then at least one texture coefficient is calculated in a fitting manner. However, this method has limitations. The fixed texture base determines a final range characterizing colors of a three-dimensional reconstruction model. For example, if a European face base is used, the at least one texture coefficient cannot characterize an Asian face no matter how the at least one texture coefficient trained. If the texture base is generated through training, non-convergent and unstable training are caused by simultaneously training the texture base and the at least one texture coefficient.

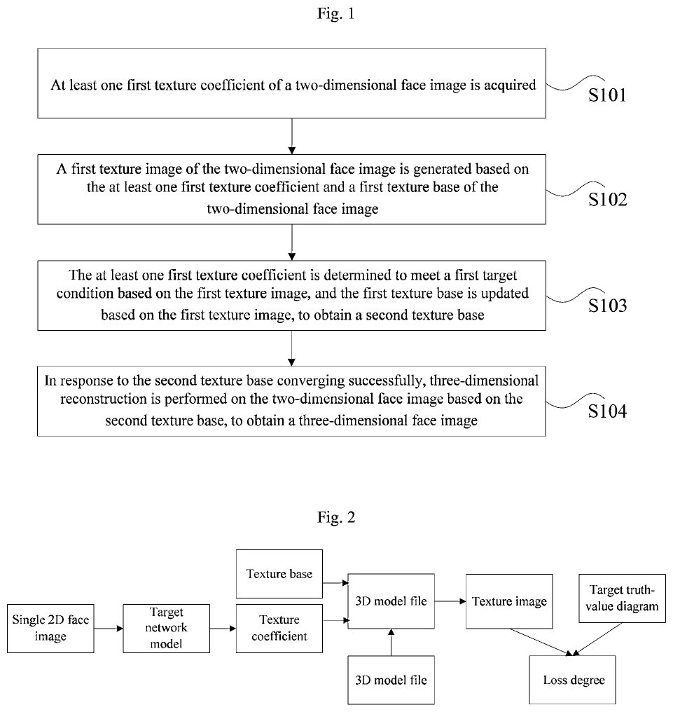

FIG. 1 is a flowchart of an image processing method according to an embodiment of the present disclosure. As shown in FIG. 1, the method may include the following steps.

At S101, at least one first texture coefficient of a two-dimensional face image is acquired.

In the technical solution provided in the step S101 of the present disclosure, before the at least one first texture coefficient of the two-dimensional face image is acquired, the two-dimensional face image is required to be collected.

In this embodiment, the at least one first texture coefficient may be obtained by inputting the collected two-dimensional face image into a target network model for processing.

Optionally, the at least one first texture coefficient may be obtained by inputting the two-dimensional face image into the target network model for prediction. For example, the two-dimensional face image is inputted into a Convolutional Neural Network (CNN) for predicting the at least one first texture coefficient. An input layer of the CNN may process multidimensional data. Since the CNN is widely applied in a field of computer vision, three-dimensional input data, that is, binary pixels and color channels (RGB channels) on a plane, is assumed in advance when a structure of the CNN is introduced. As a gradient descent algorithm is used for learning, at least one input feature of the CNN needs to be standardized.

At S102, a first texture image of the two-dimensional face image is generated based on the at least one first texture coefficient and a first texture base of the two-dimensional face image.

In the technical solution provided in the step S102 of the present disclosure, after the at least one first texture coefficient of the two-dimensional face image is acquired, the first texture image of the two-dimensional face image may be generated based on the at least one first texture coefficient and the first texture base of the two-dimensional face image.

In this embodiment, the first texture base may be a value of a texture base of the collected two-dimensional face image. The at least one first texture coefficient and the first texture base are calculated through linear summation, so as to generate the first texture image of the two-dimensional face image.

At S103, the at least one first texture coefficient is determined to meet a first target condition based on the first texture image, and the first texture base is updated based on the first texture image, to obtain a second texture base.

In the technical solution provided in the step S103 of the present disclosure, after the first texture image of the two-dimensional face image is generated based on the at least one first texture coefficient and the first texture base of the two-dimensional face image, whether the at least one first texture coefficient satisfies the first target condition is determined based on the first texture image. If the at least one first texture coefficient is determined to satisfy the first target condition based on the first texture image, the first texture base is updated based on the first texture image to obtain the second texture base.

In this embodiment, the first target condition may be used for determining whether a difference between the first texture image and a target truth-value diagram corresponding to the two-dimensional face image is within an acceptable range. When the generated first texture image satisfies the first target condition, the first texture base is updated based on the first texture image to obtain the second texture base.

Optionally, the first target condition may be that, if the loss degree of the first texture image is decreased within a certain threshold range of an RGB average single-channel loss value, the at least one texture coefficient is determined to be stably trained. For example, the first target condition may be that the loss degree of the first texture image is decreased within 10 of the RGB average single-channel loss value.

At S104, in response to the second texture base converging successfully, three-dimensional reconstruction is performed on the two-dimensional face image based on the second texture base, to obtain a three-dimensional face image.

In the technical solution provided in the step S104 of the present disclosure, after the first texture base is updated based on the first texture image to obtain the second texture base, whether three-dimensional reconstruction is performed on the two-dimensional face image based on the second texture base may be determined by determining whether the second texture base converges, so as to obtain the three-dimensional face image. In response to the second texture base converging, three-dimensional reconstruction may be performed on the two-dimensional face image based on the second texture base, to obtain the three-dimensional face image.

Through the above-mentioned S101 to S104 of the present application, the at least one first texture coefficient of the two-dimensional face image is acquired. The first texture image of the two-dimensional face image is generated based on the at least one first texture coefficient and the first texture base of the two-dimensional face image. The at least one first texture coefficient is determined to satisfy the first target condition based on the first texture image, and the first texture base is updated based on the first texture image, to obtain the second texture base. In response to the second texture base converging successfully, three-dimensional reconstruction is performed on the two-dimensional face image based on the second texture base, to obtain the three-dimensional face image. That is to say, in the present disclosure, by means of a manner of alternately training the at least one texture coefficient and the texture base until the texture base converges, three-dimensional reconstruction is performed on the two-dimensional face image based on the converged texture base, to obtain the three-dimensional face image. In this way, convergence is achieved by training the texture base of the texture image. Therefore, a technical problem of low reconstruction efficiency of the three-dimensional face image can be solved, and a technical effect of enhancing the reconstruction efficiency of the three-dimensional face image can be achieved.

The above method of this embodiment is further described in detail below.

As an optional implementation, the step S104 that in response to the second texture base converging successfully, three-dimensional reconstruction is performed on the two-dimensional face image based on the second texture base, to obtain the three-dimensional face image may include: in response to the second texture base converging unsuccessfully, a second texture image of the two-dimensional face image is generated based on the at least one first texture coefficient and the second texture base; the at least one second texture coefficient is determined to satisfy a second target condition based on the second texture image, and the at least one first texture coefficient is updated, to obtain at least one second texture coefficient; and the at least one second texture coefficient is determined as the at least one first texture coefficient, the second texture base is determined as the first texture base, and the step of generating the first texture image of the two-dimensional face image based on the at least one first texture coefficient and the first texture base of the two-dimensional face image is performed, until the second texture base converges.

In this embodiment, in response to the second texture base converging unsuccessfully, the second texture image of the two-dimensional face image is generated based on the at least one first texture coefficient and the second texture base. The second texture image may be rendered by using a differentiable renderer. Optionally, linear operation is performed on the at least one first texture coefficient and the second texture base to obtain a second face image. Then, the second face image is mapped to 3D point cloud to obtain a mesh, and then the mesh and a 3D model file (OBJ) are outputted to the differentiable renderer to render the second texture image, so as to obtain the second texture image.

In this embodiment, if the second texture base is determined to satisfy the second target condition based on the second texture image, the at least one first texture coefficient is updated to obtain the at least one second texture coefficient. The second target condition is used for determining whether the second texture base conforms to requirements. The second target condition may be that an expression range of the texture base is enlarged. Before the at least one first texture coefficient is updated, the method further may include: the weight of each of at least one parameter of the target network model is updated; and the at least one first texture coefficient is adjusted to the at least one second texture coefficient based on the updated target network model. When the at least one texture coefficient is trained to reach a stable value, as a tensor, the gradient of the texture base participates in a gradient return process of the CNN, and the weight of each of at least one parameter starts to be updated, so as to obtain the at least one second texture coefficient.

In this embodiment, the at least one second texture coefficient is determined as the at least one first texture coefficient. The second texture base is determined as the first texture base. The step of generating the first texture image of the two-dimensional face image based on the at least one first texture coefficient and the first texture base of the two-dimensional face image is performed, until in response to the second texture base converging, the first texture image of the two-dimensional face image is generated based on the at least one first texture coefficient and the first texture base of the two-dimensional face image. The at least one first texture coefficient is predicted by inputting the two-dimensional face image into the target network model CNN in the step S101. The first texture base is a value of the above texture base that is inputted into the target network model and used for predicting the face image of the at least one first texture coefficient. Optionally, the texture base of the face image prepared in advance may be a 155*1024*1024 dimensional tensor. That is to say, when training starts, the first texture base is a fixed value. During a process of training, in response to the second texture base converging unsuccessfully, and then the at least one texture coefficient is updated according to a gradient when a loss degree of the rendering image is fed back to the texture base. The second texture base participates in the process of training as a tensor. The at least one first texture coefficient and the first texture base are calculated through linear summation, so as to generate the texture image of the two-dimensional face image.

As an optional implementation, the second texture base is determined to satisfy a second target condition based on the second texture image may include: the second texture image is rendered to obtain a first rendered image; a first loss degree between the first rendered image and a target truth-value diagram corresponding to the two-dimensional face image is acquired; and in response to the first loss degree being within a target threshold range, and then the second texture base is determined to satisfy the second target condition.

In this embodiment, the second target condition may be that the expression range of training the texture base is enlarged.

In this embodiment, when the first texture image is rendered, the generated second texture image may be inputted into the differentiable renderer to obtain the first rendered image. An inverse rendering process under the differentiable renderer may include the following: the first texture image and the 3D model file (OBJ) in the target network model CNN are merged to obtain the mesh. That is to say, the first texture image is mapped to the 3D point cloud to obtain the mesh. Then, the mesh is inputted into the differentiable renderer to render the second texture image.

In this embodiment, the above mentioned OBJ may be given in the model, or may be generated through training, which is not limited herein.

In this embodiment, the first loss degree between the first rendered image and the target truth-value diagram corresponding to the two-dimensional face image is acquired. By comparing a difference between a first rendered image obtained by rending the second texture image and the two-dimensional face image, the difference is quantified, and then the first loss degree between the first rendered image and the target truth-value diagram corresponding to the two-dimensional face image is calculated.

In this embodiment, if the first loss degree is determined within the target threshold range, the second texture base is determined to satisfied the second target condition, wherein the target threshold range may be that the loss degree is decreased within 10 of the RGB average single-channel loss value. That is to say, the texture coefficient is stably trained. The second target condition may be that the expression range of training the texture base is enlarged. In order to make the difference between the first rendered image and the target truth-value diagram corresponding to the two-dimensional face image to be smaller, the target threshold range is determined to be a value range that is small enough. That is to say, the higher the required stringency, the smaller the target threshold range, so that the first rendered image is closer to the target truth-value diagram corresponding to the two-dimensional face image.

As an optional implementation, the step S101 that the at least one first texture coefficient of the two-dimensional face image is acquired may include: the two-dimensional face image is input into the target network model for processing to obtain the at least one first texture coefficient, wherein the target network model is used for predicting at least one texture coefficient of an input image. The step that the at least one first texture coefficient is updated, to obtain at least one second texture coefficient may include: the weight of each of at least one parameter of the target network model is updated; and the at least one first texture coefficient is adjusted to the at least one second texture coefficient based on the updated target network model.

In this embodiment, the two-dimensional face image is inputted into the target network model for processing, to obtain the at least one first texture coefficient, wherein the target network model is used for predicting the at least one texture coefficient of the input image, and may be the CNN. An input layer of the CNN may process multidimensional data. Since the CNN is widely applied in the field of computer vision, three-dimensional input data, that is, binary pixels and RGB channels on a plane, is assumed in advance when a structure of the CNN is introduced. As a gradient descent algorithm is used for learning, the at least one input feature of the CNN is required to be standardized.

In this embodiment, the step that the at least one first texture coefficient is updated, to obtain at least one second texture coefficient may include: the weight of each of at least one parameter of the target network model is updated; and the at least one first texture coefficient is adjusted to the at least one second texture coefficient based on the updated target network model. When the texture coefficient is trained to reach a stable value, as a tensor, the gradient of the texture base participates in a gradient return process of the CNN, and the weight each of at least one parameter starts to be updated, so that the CNN re-predicts the at least one texture coefficient of the face image. Therefore, the at least one first texture coefficient is updated, so as to obtain the at least one second texture coefficient after the at least one first texture coefficient is updated. Then, during a process of alternate training of the texture coefficient and the texture image, the texture base participates in the gradient return process of the CNN as a tensor, and the weight of each of at least one is updated, so that an update of the at least one first texture coefficient during the process of alternate training can be realized.

As an optional implementation, the step S103 that the at least one first texture coefficient is determined to satisfy the first target condition based on the first texture image may include: the first texture image is rendered to obtain a second rendered image; a second loss degree between the second rendered image and the target truth-value diagram corresponding to the two-dimensional face image is acquired; and in response to the second loss degree being within the target threshold range, and the at least one first texture coefficient is determined to satisfy the first target condition.

In this embodiment, the first texture image is rendered to obtain the second texture image. When the first texture image is rendered, the generated first texture image generated in the step S102 may be inputted into the differentiable renderer to obtain the second rendered image. An inverse rendering process under the differentiable renderer may include the following: the first texture image and the 3D model file (OBJ) in the target network model CNN are merged to obtain the mesh. That is to say, the first texture image is mapped to the 3D point cloud to obtain the mesh. Then, the mesh is inputted into the differentiable renderer to render the second texture image.

In this embodiment, the second loss degree between the second rendered image and the target truth-value diagram corresponding to the two-dimensional face image is acquired. The second loss degree between the second rendered image and the target truth-value diagram corresponding to the two-dimensional face image is calculated. That is to say, a difference between the second rendered image and the target truth-value diagram corresponding to the two-dimensional face image is compared, so as to quantify the difference with the second loss degree.

In this embodiment, if the second loss degree is determined within the target threshold range, the at least one first texture coefficient is determined to satisfy the first target condition. By determining whether the second loss degree is within the target threshold range, whether the at least one first texture coefficient satisfies the first target condition is further determined. In order to make the difference between the second rendering image and the target truth-value diagram corresponding to the two-dimensional face image be smaller, the target threshold range is determined to be a value range that is small enough. That is to say, the higher the stringency required, the smaller the target threshold range, so that the second rendering image is closer to the target truth-value diagram corresponding to the two-dimensional face image. The first target condition may be that the second loss degree is decreased within 10 of the RGB average single-channel loss value, that is to say, the texture coefficient is stably trained.

As an optional implementation, the step S103 that the first texture base based on the first texture image is updated, to obtain the second texture base may include: the first texture base is adjusted to the second texture base based on the second loss degree.

In this embodiment, the second loss degree is decreased within 10 of the RGB average single-channel loss value, that is to say, the texture coefficient is stably trained.

As an optional implementation, the method further may include: a tensor of the first texture base is adjusted based on the second loss degree. A texture base corresponding to the adjusted tensor is determined as the second texture base.

In this embodiment, the texture base is a tensor during initialization. When the at least one texture coefficient is trained, as a tensor, the gradient of the texture base may be zero, and the weight of each one the at least one texture coefficient is not updated. When the at least one texture coefficient is trained to reach a stable value, the texture base participates in the process of training. In response to the second loss degree being within the target threshold range, a tensor of the first texture base is updated based on the second loss degree. Then, the texture base corresponding to the updated tensor is determined as the second texture base.

As an optional implementation, the step S104 that three-dimensional reconstruction on the two-dimensional face image is performed based on the second texture base, to obtain the three-dimensional face image may include: a second texture image of the two-dimensional face image is generated based on the at least one first texture coefficient and the second texture base; and three-dimensional reconstruction is performed on the two-dimensional face image based on the second texture image, to obtain the three-dimensional face image.

In this embodiment, in response to the second texture base converging successfully, alternate training is ended, and the converged second texture base and the at least one first texture coefficient are calculated through linear summation, to generate the second texture image. Then, the first texture image is mapped to the 3D point cloud to obtain the mesh, and the three-dimensional face image is rendered the mesh.

In this embodiment, in response to the second texture base converging unsuccessfully, the second texture image of the two-dimensional face image is generated based on the at least one first texture coefficient and the second texture base. The at least one second texture coefficient is determined to satisfy the second target condition based on the second texture image, and the at least one first texture coefficient is updated to obtain the at least one second texture coefficient. The at least one second texture coefficient is determined as the at least one first texture coefficient. The second texture base is determined as the first texture base. The step of generating the first texture image of the two-dimensional face image based on the at least one first texture coefficient and the first texture base of the two-dimensional face image is performed, until the second texture base converges. Therefore, a convergence effect of the texture base is further guaranteed, the technical problem of low reconstruction efficiency of the three-dimensional face image can be resolved, and the technical effect of enhancing the reconstruction efficiency of the three-dimensional face image can be achieved.

FIG. 2 is a schematic flowchart of generating a rendering image according to an embodiment of the present disclosure. As shown in FIG. 2, the flow may include the following steps.

First, a single 2D face image is acquired.

Next, the acquired single 2D face image is inputted into the target network model to predict at least one first texture coefficient, wherein the target network model may be the CNN, and the CNN outputs the at least one first texture coefficient (Tex param) of the 2D face image.

Then, the 2D face image provides the texture base (Tex base), and the texture base and the at least one first texture coefficient are calculated through linear summation, to generate a first texture image.

Finally, the generated first texture image and the 3D model file OBJ are merged to obtain the mesh, and then the mesh is inputted into the differentiable renderer to generate a 2D rendering image.

In this embodiment, the at least one first texture coefficient and the texture base are calculated through linear summation to obtain the first texture image. The first texture image is mapped to the 3D point cloud to obtain the mesh, and then the mesh is inputted into the differentiable renderer to generate a second texture image. The second texture image is used for calculating a loss degree with the target truth-value diagram, so that the loss degree is determined to be within a target threshold range.

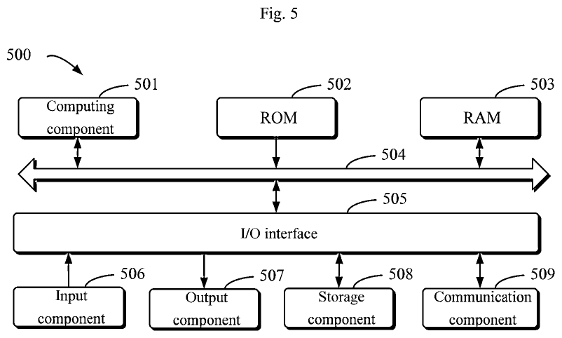

FIG. 3 is a schematic diagram of a method for calculating a loss degree based on the flow of generating the rendering image shown in FIG. 2. As shown in the FIG. 3, the method may include the following steps.

At S301, a single two-dimensional face image is acquired.

At S302, the two-dimensional face image is inputted into the target network model CNN.

In the technical solution provided in the step S302 of the present disclosure, the target network model CNN is used for predicting the at least one first texture coefficient of the two-dimensional face image. Furthermore, in response to the second texture base converging unsuccessfully, the second texture image of the two-dimensional face image is generated based on the at least one first texture coefficient and the second texture base. The second texture base is determined to satisfy the second target condition based on the second texture image, and the at least one first texture coefficient is updated to obtain the at least one second texture coefficient. The at least one second texture coefficient is determined as the at least one first texture coefficient. The second texture base is determined as the first texture base. The step of generating the first texture image of the two-dimensional face image based on the at least one first texture coefficient and the first texture base of the two-dimensional face image is performed, until the second texture base converges. During this process, the at least one texture coefficient is predicted by the target network model CNN. The weight of each of at least one texture coefficient of the target network model CNN is also updated.

At S303, the at least one texture coefficient and the texture base are calculated through linear summation to obtain the texture image.

At S304, the generated texture image and the OBJ file of the model are merged to obtain the mesh, and then the mesh is inputted into the differentiable renderer to generate the 2D rendering image.

At S305, the loss degree between the 2D face rendering image and a target face truth-value diagram (Gt diagram) is calculated.

In the technical solution provided in the step S305 of the present disclosure, the loss degree is decreased within 10 of the RGB average single-channel loss value, that is to say, the at least one texture coefficient is stably trained.

In this embodiment, the loss degree between the two-dimensional rendered image of the texture image generated during training and the target truth-value diagram is calculated.

An image processing apparatus configured to perform the embodiment shown in FIG. 1 is provided in an embodiment of the present disclosure.

FIG. 4 is a schematic diagram of an image processing apparatus according to an embodiment of the present disclosure. As shown in FIG. 4, the image processing apparatus 40 may include an acquisition component 41, a generation component 42, an update component 43, and a reconstruction component 44.

The acquisition component 41 is configured to acquire at least one first texture coefficient of a two-dimensional face image. A CNN may be used as a target network model. A two-dimensional face image is inputted into the CNN to predict the at least one first texture coefficient. During alternate training, the acquisition component 41 is used for predicting at least one second texture coefficient of a second texture image generated based on a second texture base, and then the at least one second texture coefficient is determined as the at least one first texture coefficient to continuously train the texture base, until the texture base is stabilized.

The generation component 42 is configured to generate a first texture image of the two-dimensional face image based on the at least one first texture coefficient and a first texture base of the two-dimensional face image. The generation component 42 may include a differentiable renderer. Optionally, in the generation component, the at least one first texture coefficient and the first texture base are calculated through linear summation, to obtain a first face image. Then, the first face image is mapped to 3D point cloud to obtain a mesh, and the mesh and OBJ are inputted into the differentiable renderer to render the texture image, so that the first texture image is obtained.

The update component 43 is configured to determine that the at least one first texture coefficient satisfies a first target condition based on the first texture image, and update the first texture base based on the first texture image, to obtain a second texture base. During alternate training, in response to the second texture base converging unsuccessfully, the second texture image of the two-dimensional face image is generated based on the at least one first texture coefficient and the second texture base. The second texture base is determined to satisfy the second target condition based on the second texture image. The second target condition may be that the expression range of training the texture base is enlarged. The weight of each of at least one parameter of the target network model is updated, so that the at least one first texture coefficient is updated. The at least one second texture coefficient is predicted by the CNN model. Then, the at least one second texture coefficient is determined as the at least one first texture coefficient. The second texture base is determined as the first texture base. The step of generating the first texture image of the two-dimensional face image based on the at least one first texture coefficient and the first texture base of the two-dimensional face image is performed, until the second texture base converges.

The reconstruction component 44 is configured to, in response to the second texture base converging successfully, perform three-dimensional reconstruction on the two-dimensional face image based on the second texture base, to obtain a three-dimensional face image. When the second texture base converges, the second texture image of the two-dimensional face image is generated based on the at least one first texture coefficient and the second texture base. Three-dimensional reconstruction is performed on the two-dimensional face image based on the second texture image, to obtain the three-dimensional face image.

In the image processing apparatus in this embodiment, the at least one texture coefficient of the two-dimensional face image is predicted through the CNN. The texture base of the two-dimensional face image and the at least one texture coefficient are alternately trained. The texture base of the texture image finally converged. Therefore, the technical problem of low reconstruction efficiency of the three-dimensional face image can be solved, and the technical effect of enhancing the reconstruction efficiency of the three-dimensional face image can be achieved.

In the technical solution of the present disclosure, the involved acquisition, storage, and application of personal information of a user are in compliance with relevant laws and regulations, and does not violate public order and good customs.

According to an embodiment of the present disclosure, an electronic device, a non-transitory computer-readable storage medium, and a computer program product are further provided in the present disclosure.

An electronic device is provided in an embodiment of the present disclosure. The electronic device may include: at least one processor; and a memory, communicatively connected to the at least one processor. The memory stores at least one instruction executable by the at least one processor. The at least one instruction is performed by the at least one processor, to cause the at least one processor to perform the image processing method provided in the embodiments of the present disclosure.

Optionally, the electronic device may further include a transmission device and an input/output device. The transmission device is connected to the at least one processor. The input/output device is connected to the at least one processor.

Optionally, in this embodiment, the non-transitory computer-readable storage medium may be configured to store a computer program for performing the following steps.

At S101, at least one first texture coefficient of a two-dimensional face image is acquired.

At S102, a first texture image of the two-dimensional face image is generated based on the at least one first texture coefficient and a first texture base of the two-dimensional face image.

At S103, the at least one first texture coefficient is determined to satisfy a first target condition based on the first texture image, and the first texture base is updated based on the first texture image, to obtain a second texture base.

At S104, in response to the second texture base converging successfully, three-dimensional reconstruction is performed on the two-dimensional face image based on the second texture base, to obtain a three-dimensional face image.

Optionally, in this embodiment, the non-transitory computer-readable storage medium may include, but is not limited to, an electronic, magnetic, optical, electromagnetic, infrared, or semiconductor system, device, or apparatus, or any foregoing suitable combinations. More specific examples of the readable storage medium may include electrical connections based on at least one wire, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any above suitable combinations.

A computer program product, including a computer program, is further provided in an embodiment of the present disclosure. When the computer program is performed by at least one processor, the following steps are implemented.

At S101, at least one first texture coefficient of a two-dimensional face image is acquired.

At S102, a first texture image of the two-dimensional face image is generated based on the at least one first texture coefficient and a first texture base of the two-dimensional face image.

At S103, the at least one first texture coefficient is determined to satisfy a first target condition based on the first texture image, and the first texture base is updated based on the first texture image, to obtain a second texture base.

At S104, in response to the second texture base converging successfully, three-dimensional reconstruction is performed on the two-dimensional face image based on the second texture base, to obtain a three-dimensional face image.

FIG. 5 is a schematic block diagram of an electronic device according to an embodiment of the present disclosure. The electronic device is intended to represent various forms of digital computers, such as laptop computers, desktop computers, workbenches, personal digital assistants, servers, blade servers, mainframe computers, and other suitable computers. The electronic device may also express various forms of mobile devices, such as personal digital processing, cellular phones, smart phones, wearable devices, and other similar computing devices. The components shown herein, connections and relationships of the components, and functions of the components are merely examples, and are not intended to limit the implementation of the present disclosure described and/or required herein.

FIG. 5 is a schematic block diagram of an example electronic device 500 configured to implement an embodiment of the present disclosure. The electronic device is intended to represent various forms of digital computers, such as laptop computers, desktop computers, workbenches, personal digital assistants, servers, blade servers, mainframe computers, and other suitable computers. The electronic device may also express various forms of mobile devices, such as personal digital processing, cellular phones, smart phones, wearable devices, and other similar computing devices. The components shown herein, connections and relationships of the components, and functions of the components are merely examples, and are not intended to limit the implementation of the present disclosure described and/or required herein.

As shown in FIG. 5, the device 500 may include a computing component 501. The computing component may perform various appropriate actions and processing operations according to a computer program stored in a Read-Only Memory (ROM) 502 or a computer program loaded from a storage component 508 into a Random Access Memory (RAM) 503. In the RAM 503, various programs and data required for the operation of the device 500 may also be stored. The computing component 501, the ROM 502, and the RAM 503 are connected to each other by using a bus 504. An Input/Output (I/O) interface 505 is also connected to the bus 504.

Multiple components in the device 500 are connected to the I/O interface 505, and include: an input component 506, such as a keyboard and a mouse; an output component 507, such as various types of displays and loudspeakers; the storage component 508, such as a disk and an optical disc; and a communication component 509, such as a network card, a modem, and a wireless communication transceiver. The communication component 509 allows the device 500 to exchange information/data with other devices through a computer network, such as the Internet, and/or various telecommunication networks.

The computing component 501 may be various general and/or special processing assemblies with processing and computing capabilities. Some examples of the computing component 501 include, but are not limited to, a Central Processing Unit (CPU), a Graphics Processing Unit (GPU), various dedicated Artificial Intelligence (AI) computing chips, various computing components for running machine learning model algorithms, a Digital Signal Processor (DSP), and any appropriate processors, controllers, microcontrollers, and the like. The computing component 501 performs the various methods and processing operations described above, for example, the method for calculating the loss degree between the two-dimensional rendering image of the generated texture image and the target truth-value diagram. For example, in some embodiments, the method for calculating the loss degree between the two-dimensional rendering image of the generated texture image and the target truth-value diagram may be implemented as a computer software program, which is tangibly included in a machine-readable medium, such as the storage component 508. In some embodiments, part or all of the computer program may be loaded and/or installed on the device 500 via the ROM 502 and/or the communication component 509. When the computer program is loaded into the RAM 503 and performed by the computing component 501, at least one steps of the method described above for calculating the loss degree between the two-dimensional rendering image of the generated texture image and the target truth-value diagram may be performed. Alternatively, in other embodiments, the computing component 501 may be configured to perform the method described above for calculating the loss degree between the two-dimensional rendering image of the generated texture image and the target truth-value diagram in any other suitable manners (for example, by means of firmware).

The various implementations of systems and technologies described herein may be implemented in a digital electronic circuit system, an integrated circuit system, a Field Programmable Gate Array (FPGA), an Application-Specific Integrated Circuit (ASIC), an Application-Specific Standard Product (ASSP), a System-On-Chip (SOC), a Complex Programmable Logic Device (CPLD), computer hardware, firmware, software, and/or a combination thereof. These various implementations may include: being implemented in at least one computer program, the at least one computer program may be performed and/or interpreted on a programmable system including at least one programmable processor. The programmable processor may be a dedicated or general programmable processor, which can receive data and at least one instruction from a storage system, at least one input device, and at least one output device, and transmit the data and instructions to the storage system, the at least one input device, and the at least one output device.

Program codes used to implement the method of the present disclosure can be written in any combination of at least one programming language. These program codes can be provided to the processors or controllers of general computers, special computers, or other programmable data processing devices, so that, when the program codes are performed by the at least one processor or at least one controller, functions/operations specified in the flowcharts and/or block diagrams are implemented. The program codes can be performed entirely on a machine, partially performed on the machine, and partially performed on the machine and partially performed on a remote machine as an independent software package, or entirely performed on the remote machine or a server.

In the context of the present disclosure, a machine-readable medium may be a tangible medium, which may include or store a program for being used by an instruction execution system, device, or apparatus or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, device, or apparatus, or any foregoing suitable combinations. More specific examples of the machine-readable storage medium may include electrical connections based on at least one wire, a portable computer disk, a hard disk, an RAM, an ROM, an Erasable Programmable Read-Only Memory (EPROM or flash memory), an optical fiber, a portable Compact Disk Read-Only Memory (CD-ROM), an optical storage device, a magnetic storage device, or any above suitable combinations.

In order to provide interaction with a user, the system and technologies described herein can be implemented on a computer, including a display device for displaying information to the user (for example, a Cathode Ray Tube (CRT) or a Liquid Crystal Display (LCD) monitor), a keyboard and a pointing device (for example, a mouse or a trackball). The user can provide an input to the computer by using the keyboard and the pointing device. Other types of devices may also be configured to provide interaction with the user, for example, the feedback provided to the user may be any form of sensory feedback (such as visual feedback, auditory feedback, or tactile feedback), and may be the input from the user received in any form (including acoustic input, voice input, or tactile input).

The system and technologies described herein may be implemented in a computing system (for example, as a data server) including a back-end component, or a computing system (for example, an application server) including a middleware component, or a computing system (for example, a user computer with a graphical user interface or network browser, the user may be in interaction with implementations of the system and technologies described herein by using the graphical user interface or network browser) including a front-end component, or a computing system including any combination of the back-end component, the middleware component, or the front-end component. The components of the system can be connected to each other through any form or digital data communication (for example, a communication network) of the medium. Examples of the communication network include a Local Area Network (LAN), a Wide Area Network (WAN), and the Internet.

The computer system may include a client and a server. The client and the server are generally far away from each other and usually interact by means of the communication network. A relationship between the client and the server is generated by the computer program that is run on the corresponding computer and has a client-server relationship with each other. The server may be a cloud server, and may also be a distributed system server, or a server combined with a block chain.

It is to be understood that, the steps may be reordered, added or deleted by using various forms of programs shown above. For example, the steps described in the present disclosure may be performed parallelly, sequentially, or in a different orders, as long as desired results of the technical solutions disclosed in the present disclosure can be achieved, which are not limited herein.

The foregoing specific implementations do not constitute limitations on the protection scope of the present disclosure. Those skilled in the art should understand that, various modifications, combinations, sub-combinations and substitutions can be made according to design requirements and other factors. Any modifications, equivalent replacements, improvements and the like made within the spirit and principle of the present disclosure shall fall within the scope of protection of the present disclosure.

What is claimed is:

1. An image processing method, comprising:
acquiring at least one first texture coefficient of a two-dimensional face image;
generating a first texture image of the two-dimensional face image based on the at least one first texture coefficient and a first texture base of the two-dimensional face image;
determining that the at least one first texture coefficient satisfies a first target condition based on the first texture image, and updating the first texture base based on the first texture image, to obtain a second texture base; and
in response to the second texture base converging successfully, performing three-dimensional reconstruction on the two-dimensional face image based on the second texture base, to obtain a three-dimensional face image.

2. The method of claim 1, further comprising:
in response to the second texture base converging unsuccessfully, generating a second texture image of the two-dimensional face image based on the at least one first texture coefficient and the second texture base;
determining that the second texture base satisfies a second target condition based on the second texture image, and updating the at least one first texture coefficient, to obtain at least one second texture coefficient; and
determining the at least one second texture coefficient as the at least one first texture coefficient, determining the second texture base as the first texture base, and generating the first texture image of the two-dimensional face image based on the at least one first texture coefficient and the first texture base of the two-dimensional face image, until the second texture base is determined to converge.

3. The method of claim 2, wherein determining that the second texture base satisfies a second target condition based on the second texture image comprises:
rendering the second texture image to obtain a first rendered image;
acquiring a first loss degree between the first rendered image and a target truth-value diagram corresponding to the two-dimensional face image; and
in response to the first loss degree being within a target threshold range, determining that the second texture base satisfies the second target condition.

4. The method of claim 2, wherein acquiring at least one first texture coefficient of a two-dimensional face image comprises:
inputting the two-dimensional face image into a target network model for processing to obtain the at least one first texture coefficient, wherein the target network model is used for predicting at least one texture coefficient of an input image; and
updating the at least one first texture coefficient, to obtain at least one second texture coefficient comprises: updating a weight of each of at least one parameter of the target network model; and adjusting the at least one first texture coefficient to the at least one second texture coefficient based on the updated target network model.

5. The method of claim 1, wherein determining that the at least one first texture coefficient satisfies a first target condition based on the first texture image comprises:
rendering the first texture image to obtain a second rendered image;
acquiring a second loss degree between the second rendered image and a target truth-value diagram corresponding to the two-dimensional face image; and
in response to the second loss degree being within a target threshold range, determining that the at least one first texture coefficient satisfies the first target condition.

6. The method of claim 5, wherein updating the first texture base based on the first texture image to obtain a second texture base comprises:
adjusting the first texture base to the second texture base based on the second loss degree.

7. The method of claim 6, wherein adjusting the first texture base to the second texture base based on the second loss degree comprises:
adjusting a tensor of the first texture base based on the second loss degree; and
determining a texture base corresponding to the adjusted tensor as the second texture base.

8. The method of claim 1, wherein performing three-dimensional reconstruction on the two-dimensional face image based on the second texture base to obtain a three-dimensional face image comprises:
generating a second texture image of the two-dimensional face image based on the at least one first texture coefficient and the second texture base; and
performing three-dimensional reconstruction on the two-dimensional face image based on the second texture image, to obtain the three-dimensional face image.

9. An electronic device, comprising:
at least one processor, and
a memory, communicatively connected to the at least one processor, wherein the memory is configured to store at least one instruction executable by the at least one processor, and the at least one instruction is performed by the at least one processor to cause the processor to perform the following steps:
acquiring at least one first texture coefficient of a two-dimensional face image;
generating a first texture image of the two-dimensional face image based on the at least one first texture coefficient and a first texture base of the two-dimensional face image;
determining that the at least one first texture coefficient satisfies a first target condition based on the first texture image, and updating the first texture base based on the first texture image, to obtain a second texture base; and
in response to the second texture base converging successfully, performing three-dimensional reconstruction on the two-dimensional face image based on the second texture base, to obtain a three-dimensional face image.

10. The electronic device of claim 9, further comprising:
in response to the second texture base converging unsuccessfully, generating a second texture image of the two-dimensional face image based on the at least one first texture coefficient and the second texture base;
determining that the second texture base satisfies a second target condition based on the second texture image, and updating the at least one first texture coefficient, to obtain at least one second texture coefficient; and
determining the at least one second texture coefficient as the at least one first texture coefficient, determining the second texture base as the first texture base, and generating the first texture image of the two-dimensional face image based on the at least one first texture coefficient and the first texture base of the two-dimensional face image, until the second texture base is determined to converge.

11. The electronic device of claim 10, wherein determining that the second texture base satisfies a second target condition based on the second texture image comprises:
rendering the second texture image to obtain a first rendered image;
acquiring a first loss degree between the first rendered image and a target truth-value diagram corresponding to the two-dimensional face image; and
in response to the first loss degree being within a target threshold range, determining that the second texture base satisfies the second target condition.

12. The electronic device of claim 10, wherein acquiring at least one first texture coefficient of a two-dimensional face image comprises:
inputting the two-dimensional face image into a target network model for processing to obtain the at least one first texture coefficient, wherein the target network model is used for predicting at least one texture coefficient of an input image; and
updating the at least one first texture coefficient, to obtain at least one second texture coefficient comprises:
updating weight of each of at least one parameter of the target network model; and
adjusting the at least one first texture coefficient to the at least one second texture coefficient based on the updated target network model.

13. The electronic device of claim 9, wherein determining that the at least one first texture coefficient satisfies a first target condition based on the first texture image comprises:
rendering the first texture image to obtain a second rendered image;
acquiring a second loss degree between the second rendered image and a target truth-value diagram corresponding to the two-dimensional face image; and
in response to the second loss degree being within a target threshold range, determining that the at least one first texture coefficient satisfies the first target condition.

14. The electronic device of claim 13, wherein updating the first texture base based on the first texture image, to obtain a second texture base comprises:
adjusting the first texture base to the second texture base based on the second loss degree.

15. The electronic device of claim 14, wherein adjusting the first texture base to the second texture base based on the second loss degree comprises:
adjusting a tensor of the first texture base based on the second loss degree; and
determining a texture base corresponding to the adjusted tensor as the second texture base.

16. The electronic device of claim 9, wherein performing three-dimensional reconstruction on the two-dimensional face image based on the second texture base to obtain a three-dimensional face image comprises:
generating a second texture image of the two-dimensional face image based on the at least one first texture coefficient and the second texture base; and
performing three-dimensional reconstruction on the two-dimensional face image based on the second texture image, to obtain the three-dimensional face image.

17. A non-transitory computer-readable storage medium, storing a computer instruction, wherein the computer instruction is used for a computer to perform the following steps:
acquiring at least one first texture coefficient of a two-dimensional face image;
generating a first texture image of the two-dimensional face image based on the at least one first texture coefficient and a first texture base of the two-dimensional face image;
determining that the at least one first texture coefficient satisfies a first target condition based on the first texture image, and updating the first texture base based on the first texture image to obtain a second texture base; and
in response to the second texture base converging successfully, performing three-dimensional reconstruction on the two-dimensional face image based on the second texture base, to obtain a three-dimensional face image.

18. The non-transitory computer-readable storage medium of claim 17, further comprising:
in response to the second texture base converging unsuccessfully, generating a second texture image of the two-dimensional face image based on the at least one first texture coefficient and the second texture base;
determining that the second texture base satisfies a second target condition based on the second texture image, and updating the at least one first texture coefficient, to obtain at least one second texture coefficient; and
determining the at least one second texture coefficient as the at least one first texture coefficient, determining the second texture base as the first texture base, and generating the first texture image of the two-dimensional face image based on the at least one first texture coefficient and the first texture base of the two-dimensional face image, until the second texture base is determined to converge.

19. The non-transitory computer-readable storage medium of claim 18, wherein determining that the second texture base satisfies a second target condition based on the second texture image comprises:
rendering the second texture image to obtain a first rendered image;
acquiring a first loss degree between the first rendered image and a target truth-value diagram corresponding to the two-dimensional face image; and
in response to the first loss degree being within a target threshold range, determining that the second texture base satisfies the second target condition.

20. The non-transitory computer-readable storage medium of claim 18, wherein acquiring at least one first texture coefficient of a two-dimensional face image comprises:
inputting the two-dimensional face image into a target network model for processing to obtain the at least one first texture coefficient, wherein the target network model is used for predicting at least one texture coefficient of an input image; and
updating the at least one first texture coefficient, to obtain at least one second texture coefficient comprises: updating weight of each of at least one parameter of the target network model; and adjusting the at least one first texture coefficient to the at least one second texture coefficient based on the updated target network model.
